(19) United States
(12) Patent Application Publication
(10) Pub. No.: US 2017/0253978 A1
(43) Pub. Date: Sep. 7, 2017

(54) PHOTOELECTRODE, METHOD FOR MANUFACTURING SAME, AND PHOTOELECTROCHEMICAL CELL

(71) Applicant: Panasonic Intellectual Property Management Co., Ltd., Osaka (JP)

(72) Inventors: SATORU TAMURA, Osaka (JP); KAZUHITO HATO, Osaka (JP)

(21) Appl. No.: 15/415,830

(22) Filed: Jan. 25, 2017

(30) Foreign Application Priority Data
Mar. 1, 2016 (JP) 2016-039093

(51) Int. Cl. C25B 1/00; H01G 9/20; C25B 1/04

(52) U.S. Cl. CPC C25B 1/003; C25B 1/04; H01G 9/2027

(57) ABSTRACT

The present invention provides a photoelectrode 100 includes a first conductor 101 as a substrate; a second conductor 103 which includes a plurality of pillar structures 102 disposed on the first conductor 101, and is transparent; and a photocatalyst layer 104 including a visible-light photocatalyst and disposed on the surfaces of the pillar structures 102. The photoelectrode according to the present invention is capable of effectively utilizing energy of light for an intended reaction such as a water decomposition reaction.

### BACKGROUND

1. Technical Field

The present disclosure relates to a photoelectrode, a method for manufacturing the photoelectrode, and a photoelectrochemical cell.

2. Description of the Related Art

Real practical use of renewable energy is required for realizing a sustainable society by solving a growing environmental and energy problem. Currently, systems in which electric power generated by a solar cell is stored in a storage battery are being widely spread. However, the storage battery is heavy, and thus is not easy to move.

Thus, in the future, utilization of hydrogen as an energy medium is expected.

Natures of hydrogen are as follows.

Hydrogen is easily stored and moved.

When hydrogen is burned, a resultant final product is harmless and safe water, and hence clean.

Hydrogen can be converted into electricity and heat by utilizing a fuel cell.

Hydrogen is inexhaustibly obtained by decomposition of water.

A semiconductor photoelectrode that decomposes water by sunlight to produce hydrogen is attracting attention as a technique capable of converting solar energy into hydrogen as an easily utilizable energy medium, and is being researched and developed for improving efficiency of a reaction.

For example, Patent Literature 1 discloses a semiconductor photoelectrode which includes a metal substrate having irregularities on a surface; and a semiconductor layer formed on a surface of the metal substrate and made of a material having a photocatalytic action. In this structure, light absorption efficiency is improved by light scattering from the irregular structure on the surface, and a thickness of the semiconductor layer is set to 1 μm or less to reduce recombination of charges, so that a semiconductor photoelectrode having improved energy conversion efficiency can be produced.

### CITATION LIST

### Patent Literature

Patent Literature 1 Unexamined Japanese Patent Publication No. 2006-297300

### SUMMARY

The present disclosure provides a photoelectrode including:

a first conductor as a substrate;

a second conductor which includes a plurality of pillar structures disposed on the first conductor, and is transparent; and

a photocatalyst layer including a visible-light photocatalyst and disposed on surfaces of the pillar structures.

According to the present disclosure, there can be provided a photoelectrode capable of effectively utilizing energy of light for an intended reaction such as a water decomposition reaction.

### BRIEF DESCRIPTION OF THE DRAWINGS

FIG. 1 is a schematic view showing one example of a photoelectrode according to one exemplary embodiment of the present disclosure.

FIG. 2 is a schematic view showing another example of a photoelectrode according to one exemplary embodiment of the present disclosure.

FIG. 3 is a schematic view showing a reference plane, a thickness determination plane and a central plane taking as an example the photoelectrode shown in FIG. 1.

FIG. 4 is a schematic view showing one example of a photoelectrochemical cell according to one exemplary embodiment of the present disclosure.

FIG. 5 is a schematic view showing another example of a photoelectrochemical cell according to one exemplary embodiment of the present disclosure.

### DETAILED DESCRIPTION OF THE EMBODIMENT

The semiconductor photoelectrode in Patent Literature 1 has such a problem that light incident on an electrode cannot be effectively utilized for an intended reaction such as a water decomposition reaction. This is because a part of light incident on the electrode arrives at the metal substrate after entering the semiconductor layer, and is absorbed by the metal substrate. When the semiconductor layer is thickened for increasing a light absorption amount in the semiconductor layer, a distance over which photo-excited carriers (electrons and holes) move through the semiconductor layer increases, and therefore recombination of carriers occurs, so that the carriers can no longer contribute to a reaction such as a water decomposition reaction.

An object of the present disclosure is to provide a photoelectrode capable of effectively utilizing energy of light for an intended reaction such as a water decomposition reaction.

A photoelectrode according to a first aspect of the present disclosure includes: a first conductor as a substrate; a second conductor which includes a plurality of pillar structures disposed on the first conductor, and is transparent; and a photocatalyst layer including a visible-light photocatalyst and disposed on surfaces of the pillar structures.

In the photoelectrode according to the first aspect, most of light, which is incident on the photoelectrode and enters the second conductor without being absorbed into the visible-light photocatalyst at the time of passing through the photocatalyst layer, passes through the second conductor without being absorbed into the second conductor, then enters the visible-light photocatalyst in the photocatalyst layer again, and is absorbed by the visible-light photocatalyst. Thus, in the photoelectrode according to the first aspect, light incident on the photoelectrode can enter the photocatalyst layer multiple times, and therefore even when a thickness of the photocatalyst layer is decreased, an optical path length over which the light passes through the photocatalyst layer increases, so that a light absorption rate can be improved. In other words, in the photoelectrode according to the first aspect, the thickness of the photocatalyst layer can be sufficiently decreased to suppress recombination of photo-excited carriers. Thus, in the photoelectrode according to the first aspect, most of light incident on the photoelectrode can be absorbed into the photocatalyst, and the thickness of the photocatalyst layer can be decreased to suppress recombination of photo-excited carriers, so that energy of light incident on the photoelectrode can be effectively utilized for an intended reaction such as a water decomposition reaction.

A photoelectrode according to a second aspect may be, for example, the photoelectrode according to the first aspect, wherein the visible-light photocatalyst contains at least one of a niobium nitride and a niobium oxynitride.

In the photoelectrode according to the second aspect, the visible-light photocatalyst can utilize light having a wavelength up to that in a visible light region, and a band structure of the visible-light photocatalyst is suitable for water decomposition. Thus, in the photoelectrode according to the second aspect, energy of light incident on the photoelectrode can be more effectively utilized for an intended reaction such as a water decomposition reaction when, for example, sunlight is used as a light source.

A photoelectrode according to a third aspect may be, for example, the photoelectrode according to the first or second aspect, wherein a resistivity of the first conductor is lower than a resistivity of the second conductor.

A distance over which electrons move is usually larger in the first conductor than in the second conductor. In the photoelectrode according to the third aspect, a movement loss of electrons can be suppressed because the resistivity of the first conductor may be lower than the resistivity of the second conductor.

A photoelectrode according to a fourth aspect may be, for example, the photoelectrode according to the third aspect, wherein the first conductor is formed of a metal, and the second conductor is formed of a transparent conductive oxide.

In the photoelectrode according to the fourth aspect, there is a wide range of selection of a material of the first conductor, and high conductivity of the first conductor can be achieved because the first conductor is formed of a metal. Generally, a metal has a resistivity lower than that of a transparent conductive oxide, and therefore by using a metal for formation of the first conductor, a range of selection of the transparent conductive oxide to be used for formation of the second conductor can also be widened.

A photoelectrode according to a fifth aspect may be, for example, the photoelectrode according to the third aspect, wherein the first conductor is formed of a first transparent conductive oxide, the second conductor is formed of a second transparent conductive oxide, and a resistivity of the first transparent conductive oxide is lower than a resistivity of the second transparent conductive oxide.

In the photoelectrode according to the fifth aspect, a degree of freedom of a light-incident surface in the photoelectrode is high because the first conductor is transparent. In the photoelectrode according to the fifth aspect, a surface on the first conductor side, a surface on a side opposite to the foregoing surface, or each of both the surfaces may be the light-incident surface.

A photoelectrode according to a sixth aspect may be, for example, the photoelectrode according to any one of the first to fifth aspects, wherein the second conductor is formed of at least one selected from the group consisting of antimony-doped tin oxide, fluorine-doped tin oxide and gallium-doped zinc oxide.

In the photoelectrode according to the sixth aspect, the second conductor is formed of at least one selected from the group consisting of antimony-doped tin oxide, fluorine-doped tin oxide and gallium-doped zinc oxide. Thus, the photoelectrode according to the sixth aspect is industrially easily and conveniently manufactured. Antimony-doped tin oxide and fluorine-doped tin oxide have high-temperature resistance, and therefore can be used without problems even when a step of forming a visible-light photocatalyst includes a firing process. Gallium-doped zinc oxide has high resistance in a reducing atmosphere, and therefore can be used without problems even when, for example, the visible-light photocatalyst is a nitride and/or an oxynitride, and a firing step is carried out under an ammonia gas atmosphere in synthesis of the visible-light photocatalyst.

A photoelectrode according to a seventh aspect may be, for example, the photoelectrode according to any one of the first to sixth aspects, wherein in the second conductor, a porosity of a region on a first conductor side with respect to a central plane of the second conductor is lower than a porosity of a region on a side opposite to the first conductor with respect to the central plane. Here, the central plane is a central plane in a thickness of the second conductor, the thickness of the second conductor is determined by a distance between a reference plane and a thickness determination plane where the reference plane is a surface of the first conductor on which the second conductor is disposed, and the thickness determination plane is a plane which extends through a tip of a pillar structure situated at a position farthest from the reference plane among tips of the plurality of pillar structures, and is parallel to the reference plane, and the central plane of the second conductor is a central plane between the reference plane and the thickness determination plane.

In the photoelectrode according to the seventh aspect, a probability that scattering, due to the pillar structures, of light incident on the photoelectrode from the second conductor side is directed to the first conductor side increases, and therefore the light easily arrives at an inside of the second conductor (a section of the second conductor on the first conductor side). As a result, an optical path length over which light passes through the photocatalyst layer increases, and therefore a light absorption amount of the visible-light photocatalyst increases, leading to improvement of light utilization efficiency. Further, when the photoelectrode according to the seventh aspect is utilized as an electrode for water decomposition, bubbles (of hydrogen or oxygen) produced by a water decomposition reaction in recesses (recesses formed between adjacent pillar structures) of the second conductor are easily released outside the photoelectrode.

A method for manufacturing a photoelectrode according to an eighth aspect of the present disclosure is a method for manufacturing the photoelectrode according to any one of the first to seventh aspects, the method including:

forming on a first conductor as a substrate a second conductor which includes a plurality of pillar structures, and is transparent; and

forming on surfaces of the pillar structures a photocatalyst layer including a visible-light photocatalyst.

In the manufacturing method according to the eighth aspect, a photoelectrode can be manufactured at a low cost without carrying out complicated steps.

A method according to a ninth aspect may be, for example, the method for manufacturing a photoelectrode according to the eighth aspect, wherein the visible-light photocatalyst is at least one selected from a nitride and an oxynitride, and an oxide or an organic compound as a precursor of the visible-light photocatalyst is subjected to a nitridization treatment with a nitrogen compound gas to form the photocatalyst layer including the visible-light photocatalyst.

In the manufacturing method according to the ninth aspect, a nitride and/or an oxynitride as the visible-light photocatalyst can be formed by an easy and convenient method in which an oxide or an organic compound as a precursor is subjected to a nitridization treatment.

A photoelectrochemical cell according to a tenth aspect of the present disclosure includes: the photoelectrode according to any one of the first to seventh aspects; a counter electrode electrically connected to the photoelectrode; and a container that stores the photoelectrode and the counter electrode.

The photoelectrochemical cell according to the tenth aspect includes the photoelectrode according to any one of the first to seventh aspects, so that energy of light incident on the photoelectrode can be effectively utilized for a water decomposition reaction.

A photoelectrochemical cell according to an eleventh aspect may be the photoelectrochemical cell according to the tenth aspect, further including an electrolytic solution which contains water, which is stored in the container and which is in contact with surfaces of the photoelectrode and the counter electrode.

In the photoelectrochemical cell according to the eleventh aspect, energy of light incident on the photoelectrode can be effectively utilized for a water decomposition reaction.

A photoelectrochemical cell according to a twelfth aspect may be the photoelectrochemical cell according to the tenth or eleventh aspect, wherein the first conductor of the photoelectrode is formed of a metal, and the photoelectrode is disposed in such a direction that light is capable of being incident from a surface on a side opposite to the first conductor.

In the photoelectrochemical cell according to the twelfth aspect, a part of light having arrived at a surface of the first conductor without being absorbed into the visible-light photocatalyst at the time of passing through the photocatalyst layer is reflected on the surface of the first conductor, then enters the visible-light photocatalyst in the photocatalyst layer again, and is absorbed by the visible-light photocatalyst, and therefore light utilization efficiency can be further improved.

A photoelectrochemical cell according to a thirteenth aspect is the photoelectrochemical cell according to the tenth or eleventh aspect, wherein the first conductor of the photoelectrode is formed of a transparent conductive material, and the photoelectrode is disposed in such a direction that light is capable of being incident from a surface on a first conductor side.

In the photoelectrochemical cell according to the thirteenth aspect, light is incident on the photoelectrode from the first conductor side, and therefore an amount of light absorbed by the visible-light photocatalyst included in a section of the photocatalyst layer which is close to the first conductor increases. Thus, an amount of photo-excited carriers produced at a position close to the first conductor increases. A distance over which the photo-excited carriers produced at a position close to the first conductor move to the first conductor is short, and therefore recombination of carriers is hard to occur. As a result, an amount of carriers capable of contributing to the water decomposition reaction increases, so that high utilization efficiency of energy of light can be achieved. In the photoelectrochemical cell according to the thirteenth aspect, each of both a surface on the first conductor side and a surface on a side opposite to the foregoing surface can be the light-incident surface in the photoelectrode.

Hereinafter, exemplary embodiments of the photoelectrode and the photoelectrochemical cell of the present disclosure will be described in detail. The following exemplary embodiments are illustrative, and the present disclosure is not limited to the following exemplary embodiments.

### First Exemplary Embodiment

A photoelectrode of a first exemplary embodiment includes a first conductor as a substrate, and a second conductor which includes a plurality of pillar structures disposed on the first conductor, and is transparent. A surface of the second conductor on a side opposite to the first conductor has an irregular shape formed by a plurality of pillar structures. The photoelectrode of this exemplary embodiment further includes a photocatalyst layer including a visible-light photocatalyst and formed on surfaces of a plurality of pillar structures (on the surface of the second conductor which has the irregular shape). The photocatalyst layer may be formed over a whole of the surfaces of a plurality of pillar structures, or the surfaces of a plurality of pillar structures may have a section where the photocatalyst layer is not formed.

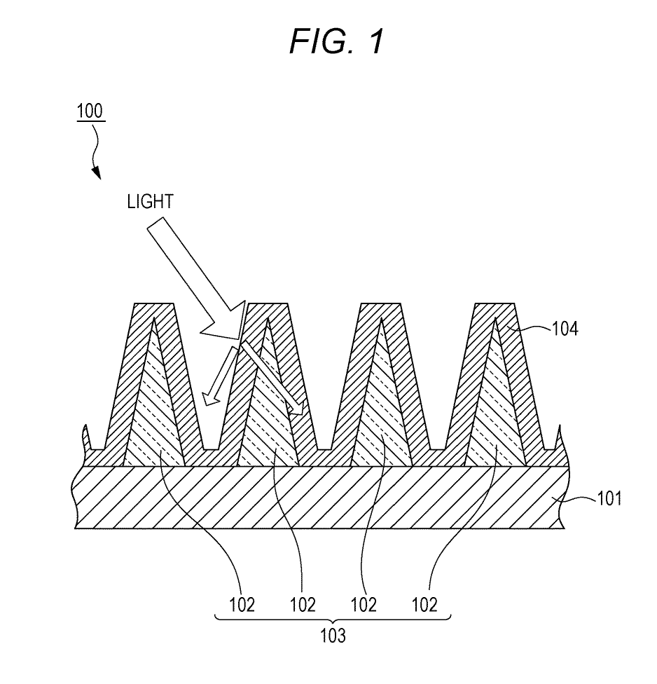

FIG. 1 is a schematic view showing one example of the photoelectrode of this exemplary embodiment. Photoelectrode 100 shown in FIG. 1 includes first conductor 101 as a substrate; second conductor 103 including a plurality of pillar structures 102 disposed on first conductor 101; and photocatalyst layer 104 including a visible-light photocatalyst and disposed on surfaces of pillar structures 102.

Preferably, a surface of photocatalyst layer 104 has an irregular shape that reflects a shape of pillar structures 102 as shown in FIG. 1. Accordingly, a surface of photoelectrode 100 on a photocatalyst layer 104 side has an irregular shape that reflects the shape of pillar structures 102. A direction in which photoelectrode 100 is installed is not particularly limited. However, in terms of light absorption, it is preferable to install photoelectrode 100 in such a manner that a light-incident direction is not parallel to a direction in which pillar structures 102 extend, and light is incident in a direction oblique to the direction in which pillar structures 102 extend. When light is incident in a direction oblique to the direction in which pillar structures 102 extend, an optical path length over which light passes through photocatalyst layer 104 increases, and therefore a light absorption rate is improved. Thus, it is preferable that with consideration given to, for example, a latitude of a land where photoelectrode 100 is installed, photoelectrode 100 is installed in such a direction and angle that the light absorption rate is further improved.

When photoelectrode 100 is utilized as an electrode for water decomposition, such an effect is obtained that bubbles (of hydrogen or oxygen) produced through a water decomposition reaction are easily released outside the photoelectrode when a surface of photoelectrode 100 on the photocatalyst layer 104 side has an irregular shape that reflects the shape of pillar structures 102. When bubbles produced on the surface of photocatalyst layer 104 of photoelectrode 100 move to an offshore side of the electrolytic solution, the bubbles can move along a straight-line route because a structure that hinders movement of the bubbles does not exist in the irregular shape that reflects the shape of pillar structures 102. Thus, accumulation of the generated bubbles on the photoelectrode is prevented, so that causes that deteriorate device properties, such as a decrease in reaction area of the photoelectrode, can be prevented.

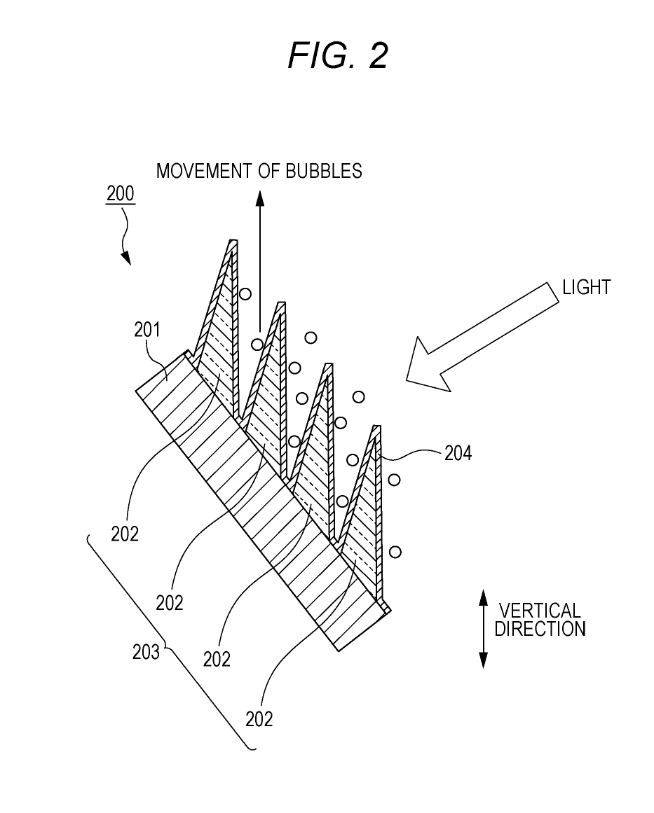

As a structure of the photoelectrode, which is suitable for release of bubbles outside the photoelectrode, mention is made of a photoelectrode in which pillar structures extend in a vertically upward direction in installation of the device. The photoelectrode may be, for example, photoelectrode 200 in which second conductor 203 is provided on first conductor 201 in such a manner that pillar structures 202 extend in a vertically upward direction in a state where the device is installed, and further, photocatalyst layer 204 having an irregular shape that reflects a shape of pillar structures 202 is provided on surfaces of pillar structures 202 as shown in FIG. 2. In photoelectrode 200 having a configuration as described above, release of bubbles from a top of the photoelectrode easily occurs because a direction in which a buoyant force acts on the bubbles is coincident with a direction in which the bubbles move. Bubbles are easily released outside the photoelectrode. That is to say, an electrolytic solution is easily transported to an electrode surface. Accordingly, reactants are easily transported to an electrode surface where a reaction proceeds, and therefore the reaction at the electrode surface is hard to undergo diffusion control, so that in the electrode, a water decomposition reaction proceeds with high efficiency.

Thus, when the photoelectrode of this exemplary embodiment is utilized as an electrode for water decomposition, it is preferable that a direction in which the photoelectrode is installed, and pillar structures of the second conductor (specifically a direction in which pillar structures extend) are determined in terms of light absorption, and also with consideration given to ease with which bubbles produced through the water decomposition reaction are released outside the photoelectrode.

In the second conductor of the photoelectrode of this exemplary embodiment, a plurality of pillar structures provide a three-dimensional structure on the surface. Constituent conductors are in close contact with each other in one pillar structure, and therefore the second conductor has a high strength. Thus, in the photoelectrode of this exemplary embodiment, the second conductor itself has a high strength, so that the photoelectrode can be used for a long period of time.

A shape of the pillar structure is not particularly limited as long as the pillar structure has a pillar shape. The pillar structure may be a cone (circular cone or pyramid) as shown in FIGS. 1 and 2, a cylinder (circular cylinder or prism), or a truncated cone (circular truncated cone or truncated pyramid). A size of the pillar structure is not particularly limited, and can be appropriately selected according to, for example, use of the photoelectrode.

In the plurality of pillar structures shown in FIGS. 1 and 2, adjacent pillar structures are not connected to each other, and are each provided in an isolated state. However, a plurality of pillar structures in the photoelectrode of this exemplary embodiment are not limited to those shown in FIGS. 1 and 2, and may be integrally provided such that adjacent pillar structures are connected to each other.

In the photoelectrode of this exemplary embodiment, most of light, which is incident on the photoelectrode and enters the second conductor without being absorbed into the visible-light photocatalyst at the time of passing through the photocatalyst layer, passes through the second conductor without being absorbed into the second conductor, then enters the visible-light photocatalyst in the photocatalyst layer again, and is absorbed by the visible-light photocatalyst.

In the structure of the photoelectrode of this exemplary embodiment, the thickness of the photocatalyst layer can be sufficiently decreased to suppress recombination of photo-excited carriers. This is because in the photoelectrode of this exemplary embodiment, light incident on the photoelectrode can enter the photocatalyst layer multiple times, and therefore even when the thickness of the photocatalyst layer itself is decreased, an optical path length over which the light passes through the photocatalyst layer increases, so that a light absorption rate can be improved. Thus, in the photoelectrode of this exemplary embodiment, most of incident light can be absorbed into the photocatalyst, and the thickness of the photocatalyst layer can be decreased to suppress recombination of photo-excited carriers, so that energy of incident light can be effectively utilized for an intended reaction such as a water decomposition reaction.

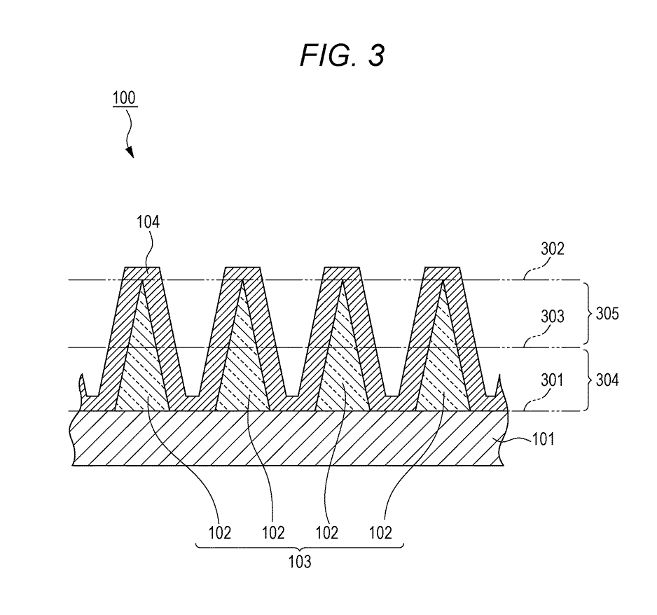

A porosity (a rate of void sections formed by recesses formed between adjacent pillar structures) in the second conductor may be almost unchanged or varied along a thickness direction of the second conductor. For example, in the second conductor, a porosity of a region on a first conductor side with respect to a central plane of the second conductor is preferably lower than a porosity of a region on a side opposite to the first conductor with respect to the central plane. Here, a thickness of the second conductor is determined by a distance between a reference plane and a thickness determination plane where the reference plane is a surface of the first conductor on which the second conductor is disposed, and the thickness determination plane is a plane which extends through a tip of a pillar structure situated at a position farthest from the reference plane among tips of a plurality of pillar structures, and is parallel to the reference plane. The central plane of the second conductor is a central plane in the thickness of the second conductor, which is a central plane between the reference plane and the thickness determination plane. The thickness direction of the second conductor is a direction perpendicular to the reference plane. The planes defined in this way will be described below taking photoelectrode 100 shown in FIG. 1 as an example. As shown in FIG. 3, reference plane 301 is a surface of first conductor 101 on which second conductor 103 (pillar structures 102) is disposed, thickness determination plane 302 is a plane which extends through tips of pillar structures 102 and is parallel to reference plane 301, and central plane 303 is a central plane between reference plane 301 and thickness determination plane 302. In FIG. 3, reference numeral 304 denotes a region on the first conductor side with respect to central plane 303, and reference numeral 305 denotes a region on a side opposite to the first conductor with respect to central plane 303.

In other words, the above-mentioned configuration is such that the second conductor is dense in the region on the first conductor side, and sparse in the region on a side opposite to the first conductor. In this configuration, a probability that scattering, due to the pillar structures, of light incident on the photoelectrode from the second conductor side is directed to the first conductor side increases. Thus, light easily arrives at an inside of the second conductor (a section of the second conductor on the first conductor side), so that an optical path length over which light passes through the photocatalyst layer increases, and therefore a light absorption amount of the visible-light photocatalyst increases, leading to improvement of light utilization efficiency. Further, when the photoelectrode of this exemplary embodiment is utilized as an electrode for water decomposition, bubbles (of hydrogen or oxygen) produced by a water decomposition reaction in recesses (recesses formed between adjacent pillar structures) in the surface of the second conductor are easily released outside the photoelectrode. More preferably, the porosity of the second conductor increases from the first conductor side toward the side opposite to the first conductor, that is to say, a density of the second conductor decreases from the first conductor side toward the side opposite to the first conductor. In this configuration, utilization efficiency of the visible-light photocatalyst can be further improved. These pillar structures can be provided by, for example, pillar structures 102 and 202 in which a diameter gradually decreases from the first conductor 101 and 201 side toward a side opposite to first conductors 101 and 201 as in second conductors 103 and 203 shown in FIG. 1 and FIG. 2.

The porosity of the second conductor can be determined by image analysis of a sectional view of the second conductor along a thickness direction of the first conductor. Specifically, the porosity can be determined in the following manner: the sectional view of the second conductor is binarized, binarized image data in which, for example, a skeleton section is white and a void section is black, is provided, and a number of pixels in the black section, i.e. the void section is counted.

The second conductor is formed of a transparent conductive material such as a transparent conductive oxide. The transparent conductive material is a material which has a low absorption ratio for light in a visible light region with a wavelength above 400 nm and which has conductivity. Here, the “low absorption ratio for light in a visible light region with a wavelength above 400 nm” means that a light absorption coefficient for light in a visible light region with a wavelength of 500 nm is 1000 cm⁻¹ or less, preferably 500 cm⁻¹ or less. Since the second conductor includes pillar structures, light incident on the second conductor may be reflected/scattered to appear white. However, since the transparent conductive material that forms the second conductor has a low light absorption coefficient in, for example, the above-mentioned range for light in a visible light region, light absorption hardly occurs in the second conductor, and most of incident light is absorbed by the visible-light photocatalyst at the time when the light passes through the visible-light photocatalyst. Conductivity required for the transparent conductive material to be used in the second conductor corresponds to a resistivity of 1×10⁻¹ Ω·cm or less, preferably a resistivity of 1×10⁻² Ω·cm or less.

Examples of the transparent conductive material to be used for formation of the second conductor in this exemplary embodiment include transparent conductive oxides such as antimony-doped tin oxide (ATO), niobium-doped tin oxide (NbTO), tantalum-doped tin oxide (TaTO), fluorine-doped tin oxide (FTO), tin-doped indium oxide (ITO), aluminum-doped zinc oxide (AZO), gallium-doped zinc oxide (GZO) and niobium-doped titanium dioxide. Preferably, the second conductor is formed of at least one selected from the group consisting of ATO, FTO and GZO in particular. By using ATO, FTO and GZO, the photoelectrode of this exemplary embodiment can be industrially easily and conveniently produced. More preferably, a material having durability to a step of forming the visible-light photocatalyst is selected as the transparent conductive material to be used in the second conductor. ATO and FTO have higher high-temperature resistance as compared to ITO, and therefore can be used without problems even when the step of forming a visible-light photocatalyst includes a firing process. GZO has high resistance in a reducing atmosphere, and therefore can be used without problems even when, for example, the visible-light photocatalyst is a nitride and/or an oxynitride, and a firing step is carried out under an ammonia gas atmosphere in synthesis of the visible-light photocatalyst.

The visible-light photocatalyst is a photocatalyst capable of absorbing light in a visible light region with a wavelength above 400 nm. The visible-light photocatalyst has a light absorption coefficient of 5000 cm⁻¹ or more, preferably 10000 cm⁻¹ or more for light in a visible light region with a wavelength of 500 nm. The visible-light photocatalyst in this exemplary embodiment can utilize visible light from sunlight as described above, and is therefore capable of increasing utilization efficiency of sunlight as compared to a photocatalyst that can absorb only ultraviolet rays, such as TiO₂. Typical examples of the photocatalyst capable of absorbing light in a visible light region include iron oxide (Fe₂O₃), tungsten oxide (WO₃), tantalum nitride (Ta₃N₅), tantalum oxynitride (TaON), niobium nitride (Nb₃N₅) and niobium oxynitride (NbON).

Particularly, when the visible-light photocatalyst is at least one of a niobium nitride and a niobium oxynitride such as niobium nitride (Nb₃N₅) and niobium oxynitride (NbON), the visible-light photocatalyst can utilize light having a wavelength up to that in a visible light region, and a band structure of the visible-light photocatalyst is suitable for water decomposition. Thus, when such a visible-light photocatalyst is used, it is possible to provide a photoelectrode capable of more effectively utilizing energy of light incident on the photoelectrode for an intended reaction such as a water decomposition reaction when, for example, sunlight is used as a light source. A niobium-based compound can be prepared at a lower cost as compared to a Ta-based compound, and is therefore suitable for industrial use.

Preferably, the thickness of the photocatalyst layer including a visible-light photocatalyst is, for example, 10 nm to 200 nm for sufficiently absorbing light and preventing recombination of photo-excited carriers. In the photoelectrode of this exemplary embodiment, most of light, which once enters the photoelectrode layer, but passes through the photocatalyst layer and arrives at the second conductor without being absorbed into the visible-light photocatalyst in the photocatalyst layer, passes through the second conductor without being absorbed into the second conductor, then enters the visible-light photocatalyst in the photocatalyst layer again, and is absorbed by the visible-light photocatalyst. Thus, the thickness of the photocatalyst layer can be reduced without decreasing the optical path length over which light incident on the photoelectrode passes through the photocatalyst layer.

Preferably, materials and Fermi levels of the photocatalyst layer and the second conductor are appropriately selected in such a manner that a contact between the photocatalyst layer and the second conductor is an ohmic contact. When the contact between the photocatalyst layer and the second conductor is an ohmic contact, a probability that electrons and holes produced in the visible-light photocatalyst by photo-excitation are charge-separated and recombined further decreases, and therefore utilization efficiency of light energy can be further improved.

The first conductor may be formed of a metal, or may be formed of a transparent conductive material. Conductivity required for the material to be used in the first conductor corresponds to a resistivity of 1×10⁻³ Ω·cm or less, preferably a resistivity of 1×10⁻⁴ Ω·cm or less. Here, the resistivity required for the material of the first conductor is lower than the resistivity required for the material of the second conductor (1×10⁻¹ Ω·cm or less, preferably 1×10⁻² Ω·cm or less) because a distance over which photo-excited electrons move through the first conductor is longer than a distance over which the electrons move through the second conductor, and therefore conductivity required for the material of the first conductor is higher than conductivity required for the material of the second conductor when consideration is given to smooth movement of electrons.

When the first conductor is made of a metal, there is a wide range of selection of a material of the first conductor, and high conductivity of the first conductor can be achieved. Examples of the metal to be used for formation of the first conductor include titanium and niobium.

On the other hand, when the first conductor is formed of a transparent conductive material, a surface on the first conductor side, or a surface on a side opposite to the foregoing surface, or each of both the surfaces may be the light-incident surface in the photoelectrode, and therefore a degree of freedom of the light-incident surface is high. Since it is also possible to produce the first conductor by use of the same material as that of the second conductor, the first conductor and the second conductor can be industrially easily and conveniently produced. As the transparent conductive material of the first conductor, the transparent conductive oxides shown as an example as the transparent conductive material to be used for formation of the second conductor can be used, and among them, FTO and ATO are suitably used. As described above, FTO and ATO have high-temperature resistance, and therefore can be used without problems even when the step of forming a visible-light photocatalyst includes a firing process.

Preferably, the first conductor is formed of a material having a resistivity lower than that of the second conductor. Preferably, the first conductor has conductivity higher than that of the second conductor. A distance over which electrons move is usually larger in the first conductor than in the second conductor. Thus, a movement loss of electrons can be suppressed by making the resistivity of the first conductor lower than the resistivity of the second conductor. This configuration can be provided by, for example, forming the first conductor from a metal and forming the second conductor from a transparent conductive oxide. Specific examples of the metal that can be used for formation of the first conductor and specific examples of the transparent conductive oxide that can be used for formation of the second conductor are as described above. By forming the first conductor from a first transparent conductive oxide, and forming the second conductor from a second transparent conductive oxide having a resistivity higher than that of the first transparent conductive oxide, a photoelectrode can be provided in which the first conductor and the second conductor are both transparent, and the resistivities of the first conductor and the second conductor satisfy the above-mentioned relationship.

One example of a method for manufacturing the photoelectrode of this exemplary embodiment will now be described. In one example of the method for manufacturing the photoelectrode of this exemplary embodiment, first, a second conductor which includes a plurality of pillar structures, and is transparent is formed on a first conductor as a substrate. Next, a photocatalyst layer including a visible-light photocatalyst and disposed on surfaces of pillar structures is formed.

Since the manufacturing method does not include complicated steps, a photoelectrode can be manufactured at a low cost. Details of materials of the first conductor to be used and the second conductor and visible-light photocatalyst to be formed in the manufacturing method are as described above.

When a visible-light photocatalyst containing at least one selected from a nitride and an oxynitride is formed, the visible-light photocatalyst can be formed by, for example, subjecting an oxide or an organic compound as a precursor of the visible-light photocatalyst to a nitridization treatment with a nitrogen compound gas (e.g. an ammonia gas). Thus, a film containing an oxide or an organic compound as a precursor of the visible-light photocatalyst is formed on a surface of the second conductor, and the precursor contained in the film is subjected to a nitridization treatment to form a photocatalyst layer including the visible-light photocatalyst.

Since a surface of the second conductor on which the photocatalyst layer is disposed has an irregular shape formed by a plurality of pillar structures, it is easy to prepare a film containing a precursor of the visible-light photocatalyst (precursor-containing film). Specifically, a whole of a surface (deposition surface) on which the precursor-containing film is to be formed is exposed to a surface of the second conductor, and therefore, for example, even in a film-forming process with a small wraparound (e.g. a sputtering method), a relatively uniform precursor-containing film can be prepared, so that a photocatalyst layer covering the whole surface of the second conductor can be produced. The photocatalyst layer produced in this manner prevents exposure of the second conductor to an electrolytic solution even when, for example, the photoelectrode being used comes into contact with the electrolytic solution, and therefore causes that deteriorate device properties, such as a dark current, can be prevented.

When the precursor is reacted into a visible-light photocatalyst by a nitridization treatment, a nitridization method using a nitrogen compound gas such as an ammonia gas causes a nitridization reaction to proceed in a depth direction from an outermost surface of the precursor such as an oxide. The precursor-containing film formed on a surface of the second conductor having an irregular shape formed by pillar structures is exposed at almost a whole surface of the film, and has a relatively uniform thickness, so that the nitridization reaction can be caused to uniformly proceed at any location. Thus, in the photoelectrode of this exemplary embodiment with the photocatalyst layer disposed on the surface of the second conductor, a high-quality photocatalyst layer can be produced by a simple nitridization process.

When the visible-light photocatalyst is a niobium oxynitride such as niobium oxynitride (NbON), the visible-light photocatalyst can be formed by, for example, subjecting the niobium oxynitride as a precursor to a nitridization treatment with an ammonia gas. The nitridization treatment can be performed under atmospheric pressure. The nitridization treatment is performed under atmospheric pressure, and thus as compared to a case where the nitridization treatment is performed under vacuum, necessity of complicated steps is eliminated, and a simpler apparatus can be used, so that costs of the photoelectrode can be further reduced. The nitridization treatment using an ammonia gas can be performed, for example, at a temperature in a range from 500° C. to 750° C., preferably in a range from 500° C. to 650° C. When the nitridization treatment is performed at a temperature in the range as described above, a sufficient nitridization treatment can be performed because the temperature is high enough to thermally decompose ammonia, and conductivity of the second conductor can be maintained after the treatment.

On the other hand, when the visible-light photocatalyst is a niobium nitride such as niobium nitride (Nb₃N₅), the visible-light photocatalyst can be formed by, for example, nitriding an organic niobium compound by reacting the organic niobium compound with an ammonia gas. As the organic niobium compound, for example, a compound represented by a compositional formula: Nb(NR₂)₅ (where R represents an alkyl group having 1 to 3 carbon atoms) (e.g. pentakis(dimethylamino)niobium) and a compound represented by a compositional formula: R¹N═Nb(NR²R³)₃ (where R¹, R² and R³ each independently represent a hydrocarbon group) can be used. A temperature for the nitridization treatment is, for example, equal to or higher than a nitridization initiation temperature of the organic niobium compound and lower than a reduction initiation temperature of Nb.

The second conductor has a relatively simple structure among three-dimensional structures because a three-dimensional structure of the second conductor is formed by a plurality of pillar structures. Thus, production of the second conductor itself is easy. A method for forming the second conductor is not particularly limited. Mention is made of, for example, a method in which a thick film is formed by a sputtering method, a vacuum vapor deposition method or the like using a material for forming the second conductor, and the thick film is subjected to etching processing, and a method in which a mold formed of a resin or the like is provided beforehand, a transparent conductive material is deposited in the mold by liquid phase deposition (LPD), and the mold is then removed. Particularly, the method using liquid phase deposition is advantageous for cost reduction, area enlargement and mass production because no vacuum process is used.

### Second Exemplary Embodiment

One exemplary embodiment of a photoelectrochemical cell of the present disclosure will be described.

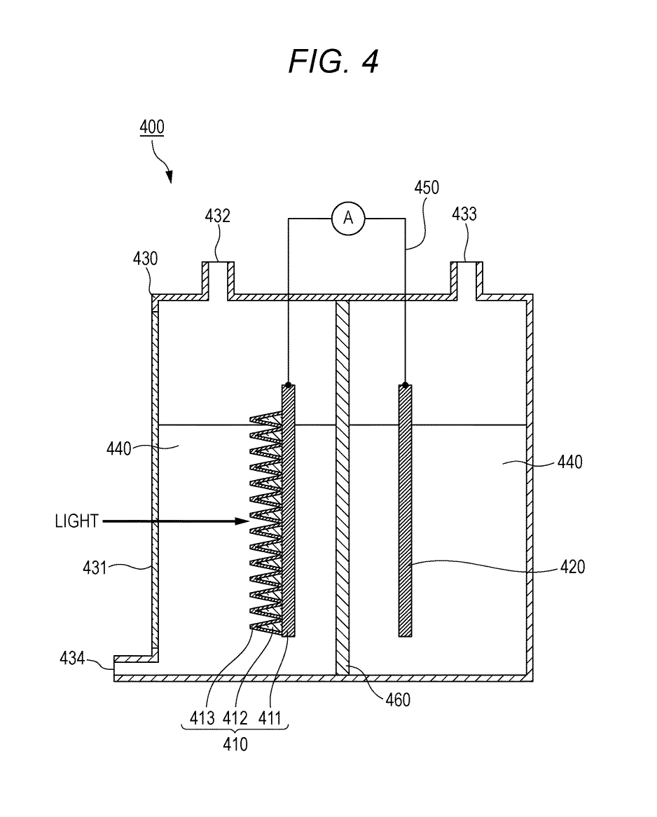

FIG. 4 shows one example of the photoelectrochemical cell of this exemplary embodiment. Photoelectrochemical cell 400 shown in FIG. 4 includes photoelectrode 410; counter electrode 420; electrolytic solution 440 containing water; and container 430 that stores photoelectrode 410, counter electrode 420, and electrolytic solution 440.

As photoelectrode 410, the photoelectrode described in the first exemplary embodiment is used. Photoelectrode 410 includes first conductor 411 as a substrate; second conductor 412 which includes a plurality of pillar structures disposed on first conductor 411, and is transparent; and photocatalyst layer 413 including a visible-light photocatalyst and disposed on surfaces of the pillar structures. First conductor 411, second conductor 412 and photocatalyst layer 413 correspond, respectively, to the first conductor, the second conductor and the photocatalyst layer described in the first exemplary embodiment, and therefore are not described in detail here.

In container 430, photoelectrode 410 and counter electrode 420 are disposed in such a manner that surfaces of photoelectrode 410 and counter electrode 420 are in contact with electrolytic solution 440. In photoelectrochemical cell 400 shown in FIG. 4, a section of container 430 which faces a photocatalyst layer 413-side surface of photoelectrode 410 disposed in container 430 (hereinafter, abbreviated as light-incident section 431) is made of a material that transmits light such as sunlight. In photoelectrochemical cell 400, photoelectrode 410 is disposed in container 430 in such a direction that light is capable of being incident from a surface on a side opposite to first conductor 411. In other words, the light-incident surface in photoelectrode 410 is the surface on a side opposite to the first conductor. Thus, first conductor 411 of photoelectrode 410 may be formed of a metal, or may be formed of a transparent conductive material. When first conductor 411 is formed of a metal, a part of light having arrived at a surface of first conductor 411 without being absorbed into the visible-light photocatalyst at the time of passing through photocatalyst layer 413 is reflected on the surface of first conductor 411, then enters the visible-light photocatalyst in photocatalyst layer 413 again, and is absorbed by the visible-light photocatalyst, and therefore light utilization efficiency can be further improved.

First conductor 411 in photoelectrode 410 and counter electrode 420 are electrically connected by lead wire 450. The counter electrode herein means an electrode that sends and receives electrons between itself and a photoelectrode without passage through an electrolytic solution. Thus, counter electrode 420 in this exemplary embodiment has only to be electrically connected to first conductor 411 that forms photoelectrode 410, and a positional relation between counter electrode 420 and photoelectrode 410, etc. is not particularly limited. For example, when the visible-light photocatalyst included in photocatalyst layer 413 in photoelectrode 410 is an n-type semiconductor, counter electrode 420 is an electrode that receives electrons from photoelectrode 410 without passage through electrolytic solution 440. Preferably, a material having a small overvoltage is used for counter electrode 420. For example, use of a metal catalyst such as Pt, Au, Ag, Fe or Ni is preferable because activity of counter electrode 420 is improved.

As shown in FIG. 4, photoelectrochemical cell 400 may further include separator 460. An inside of container 430 can be partitioned by separator 460 into two regions: a region where photoelectrode 410 is disposed and a region where counter electrode 420 is disposed. Electrolytic solution 440 is stored in both the regions. Container 430 includes exhaust port 432 for exhausting a gas produced in the region where photoelectrode 410 is disposed; and exhaust port 433 for exhausting a gas produced in the region where counter electrode 420 is disposed. Container 430 further includes water supply port 434 for supplying water into container 430.

Electrolytic solution 440 is not particularly limited as long as it contains water. Electrolytic solution 440 may be acidic or alkaline. A solid electrolyte can be used in place of electrolytic solution 440. Water can be used in place of electrolytic solution 440.

Operations of photoelectrode 410 and photoelectrochemical cell 400 will now be described. Here, an explanation is given taking as an example a case where the visible-light photocatalyst included in photocatalyst layer 413 of photoelectrode 410 is an n-type semiconductor such as NbON.

When sunlight is incident from light-incident section 431 of container 430 in photoelectrochemical cell 400 to photoelectrode 410 which is stored in container 430 and is in contact with electrolytic solution 440, electrons are produced in a conduction band, and holes are produced in a valence band in the visible-light photocatalyst in photocatalyst layer 413. Holes produced here move to a surface of photocatalyst layer 413 due to band bending by a depletion layer generated as a result of contact with electrolytic solution 440. On the surface of photocatalyst layer 413, water is decomposed to produce oxygen in accordance with the following reaction formula (1). On the other hand, electrons move to second conductor 412 due to the band bending, and arrive at counter electrode 420 by way of first conductor 411. At counter electrode 420, hydrogen is produced in accordance with the following reaction formula (2).

4h⁺+2H₂O→O₂↑+4H⁺ (1)

4e⁻+4H⁺→2H₂↑ (2)

Produced hydrogen and oxygen are separated from each other by separator 460 in the container, and oxygen is discharged through exhaust port 432 while hydrogen is exhausted through exhaust port 433. Water to be decomposed is supplied into container 430 through water supply port 434.

Photoelectrode 410 is capable of utilizing energy of light with high efficiency as described in the first exemplary embodiment. Thus, photoelectrochemical cell 400 including photoelectrode 410 is capable of effectively utilizing energy of light for a water decomposition reaction.

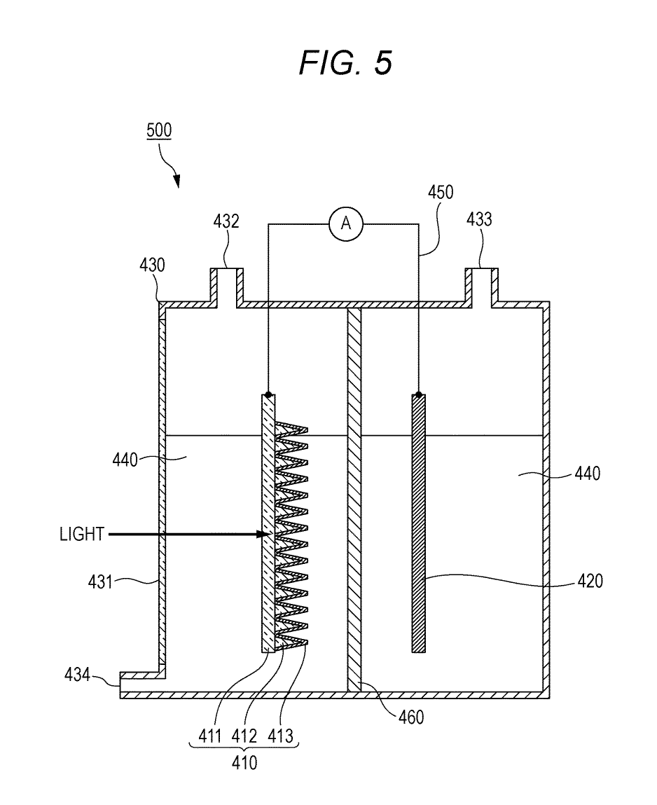

FIG. 5 shows another example of the photoelectrochemical cell. Photoelectrochemical cell 500 shown in FIG. 5 is different from photoelectrochemical cell 400 in direction of disposition of photoelectrode 410, but has the same configuration as that of photoelectrochemical cell 400 in other points. Thus, only the direction of disposition of photoelectrode 410 is described here. In photoelectrochemical cell 500, photoelectrode 410 is disposed in such a direction that first conductor 411 faces light-incident section 431 of container 430, i.e. photoelectrode 410 is disposed in container 430 in such a direction that light is capable of being incident from a surface on a first conductor 411 side. In other words, the light-incident surface in photoelectrode 410 is the surface on the first conductor 411 side. First conductor 411 is required to transmit incident light, so that the light arrives at photocatalyst layer 413. Thus, in photoelectrochemical cell 500, first conductor 411 of photoelectrode 410 is required to be formed of a transparent conductive material.

Operations of photoelectrochemical cell 500 when light is incident on photoelectrode 410 are the same as operations of photoelectrochemical cell 400 except that light arriving at photocatalyst layer 413 is light having passed through first conductor 411. However, in photoelectrochemical cell 500, light is incident on photoelectrode 410 from the first conductor 411 side, and therefore an amount of light absorbed by the visible-light photocatalyst included in a section of photocatalyst layer 413 which is close to first conductor 411 increases. Thus, a distance over which carriers photo-excited by the visible-light photocatalyst move to first conductor 411 is shorter as compared to the case of photoelectrochemical cell 400, and therefore recombination of carriers is hard to occur. As a result, in photoelectrochemical cell 500, an amount of carriers capable of contributing to the water decomposition reaction increases as compared to photoelectrochemical cell 400, so that high utilization efficiency of energy of light can be achieved. Photoelectrochemical cell 500 can be made to have a configuration in which light is incident on the photoelectrode from both of a surface on the first conductor side and a surface on a side opposite to the foregoing surface rather than only from the surface on the first conductor 411 side.

Configurations of components other than photoelectrode 410 in photoelectrochemical cells 400 and 500, for example, counter electrode 420, container 430, lead wire 450, and separator 460 are not particularly limited, and a known container, a known lead wire, a known separation membrane and so on which are used in a photoelectrochemical cell that decomposes water to produce a gas such as hydrogen can be appropriately used.

### INDUSTRIAL APPLICABILITY

The photoelectrode of the present disclosure is useful as an electrode for water decomposition using sunlight.

### REFERENTIAL SIGNS LIST

100, 200, 310 Photoelectrode
101, 201, 311 First conductor
102, 202 Pillar structure
103, 203, 412 Second conductor
104, 204, 413 Photocatalyst layer
301 Reference plane
302 Thickness determination plane
303 Central plane
304 Region on first conductor side
305 Region on side opposite to first conductor
400, 500 Photoelectrochemical cell
420 Counter electrode
430 Container
431 Light-incident section
432, 433 Exhaust port
434 Water supply port
440 Electrolytic solution
450 Lead wire
460 Separator

1. A photoelectrode comprising:
a first conductor as a substrate;
a second conductor which includes a plurality of pillar structures disposed on the first conductor, and is transparent; and
a photocatalyst layer including a visible-light photocatalyst and disposed on surfaces of the pillar structures.

2. The photoelectrode according to claim 1, wherein
the visible-light photocatalyst contains at least one of a niobium nitride and a niobium oxynitride.

3. The photoelectrode according to claim 1, wherein
a resistivity of the first conductor is lower than a resistivity of the second conductor.

4. The photoelectrode according to claim 3, wherein
the first conductor is formed of a metal, and
the second conductor is formed of a transparent conductive oxide.

5. The photoelectrode according to claim 3, wherein
the first conductor is formed of a first transparent conductive oxide,
the second conductor is formed of a second transparent conductive oxide, and
a resistivity of the first transparent conductive oxide is lower than a resistivity of the second transparent conductive oxide.

6. The photoelectrode according to claim 1, wherein
the second conductor is formed of at least one selected from the group consisting of antimony-doped tin oxide, fluorine-doped tin oxide and gallium-doped zinc oxide.

7. The photoelectrode according to claim 1, wherein
in the second conductor, a porosity of a region on a first conductor side with respect to a central plane of the second conductor is lower than a porosity of a region on a side opposite to the first conductor with respect to the central plane,
the central plane is a central plane in a thickness of the second conductor,
the thickness of the second conductor is determined by a distance between a reference plane and a thickness determination plane where the reference plane is a surface of the first conductor on which the second conductor is disposed, and the thickness determination plane is a plane which extends through a tip of a pillar structure situated at a position farthest from the reference plane among tips of the plurality of pillar structures, and is parallel to the reference plane, and
the central plane of the second conductor is a central plane between the reference plane and the thickness determination plane.

8. A method for manufacturing the photoelectrode, the method comprising:
forming on a first conductor as a substrate a second conductor which includes a plurality of pillar structures, and is transparent; and
forming, on surfaces of the pillar structures, a photocatalyst layer including a visible-light photocatalyst.

9. The method for manufacturing a photoelectrode according to claim 8, wherein
the visible-light photocatalyst is at least one selected from a nitride and an oxynitride, and
the photocatalyst is formed by subjecting an oxide or an organic compound as a precursor of the visible-light photocatalyst to a nitridization treatment with a nitrogen compound gas.

10. A photoelectrochemical cell comprising:
the photoelectrode according to claim 1;
a counter electrode electrically connected to the photoelectrode; and
a container that stores the photoelectrode and the counter electrode.

11. The photoelectrochemical cell according to claim 10, further comprising:
an electrolytic solution which contains water, which is stored in the container and which is in contact with surfaces of the photoelectrode and the counter electrode.

12. The photoelectrochemical cell according to claim 10, wherein
the first conductor of the photoelectrode is formed of a metal, and
the photoelectrode is disposed in such a direction that light is capable of being incident from a surface on a side opposite to the first conductor.

13. The photoelectrochemical cell according to claim 10, wherein
the first conductor of the photoelectrode is formed of a transparent conductive material, and
the photoelectrode is disposed in such a direction that light is capable of being incident from a surface on a first conductor side.

14. A method for producing hydrogen, the method comprising:
(a) providing a photoelectrochemical cell comprising:
the photoelectrode according to claim 1;
a counter electrode electrically connected to the photoelectrode;
a liquid that is in contact with the photoelectrode and the counter electrode; and
a container that stores the photoelectrode, the counter electrode and the liquid,
wherein
the liquid is water or an electrolyte aqueous solution; and
(b) irradiating the photoelectrode with light to produce hydrogen on a surface of the counter electrode.

15. The photoelectrode according to claim 1, wherein
a cross-sectional area of the pillar structures decreases in an increase in a distance from the substrate.
